(19) United States
(12) Patent Application Publication
(10) Pub. No.: US 2014/0353473 A1
(43) Pub. Date: Dec. 4, 2014

(54) SYSTEM AND METHOD FOR DETERMINATION OF FLAMES IN A HARSH ENVIRONMENT

(71) Applicant: General Electric Company, Schenectady, NY (US)

(72) Inventors: Lucian Vasile Stoica, Markt Nandlstadt (DE); Emad Andarawis Andarawis, Ballston Lake, NY (US); Michael Charles Spalding, Hudson, OH (US); Charles Arthur Slabaugh, Twinsburg, OH (US); Frederick Louis Glesius, Brecksville, OH (US); Cheng-Po Chen, Niskayuna, NY (US); Alexey Vasily Vert, Clifton Park, NY (US)

(73) Assignee: General Electric Company, Schenectady, NY (US)

(21) Appl. No.: 13/906,538

(22) Filed: May 31, 2013

(51) Int. Cl. G08B 17/12

(52) U.S. Cl. CPC G08B 17/12
USPC 250/214 R

(57) ABSTRACT

A system for determination of presence of flames is provided. The system includes a photosensitive transducer configured to generate a response signal that is a function of electromagnetic radiation from a flame source. The system also includes a signal processing unit that includes a modulation unit and a demodulation unit. The modulation unit is configured to generate a modulated response signal by modulating the response signal with a modulation signal of frequency higher than that of an unwanted signal present the response signal. The demodulation unit is configured to determine an output signal by demodulating the modulated response signal. The demodulation unit eliminates the unwanted signal from the modulated response signal during the determination of the output signal. Further, the system also includes a processing unit configured to process the output signal to determine flame presence based on the intensity of the incident radiation from the flame.

### BACKGROUND

The present invention relates generally to sensors for flame detection, and more particularly to, a sensor-based system and method for determination of flames in harsh environments.

It is imperative for management of combustion systems such as turbines, boilers, heaters, furnaces, and burners to detect presence of flames. Detection of flames is important to plan and schedule maintenance activities for such systems. It is also important to detect presence of flames in combustion systems to determine a state of combustion being carried out in the system. Control decisions for turbines and other systems are based on the determined state of combustion. Hence, it is important to determine an accurate state of combustion for efficient operation of combustion systems.

Many current day flame detection systems utilize photosensitive detectors. Such detectors consist of phototubes that emit electrons when illuminated by light of specific wavelengths. The emitted electrons are received by a set of receiving tubes. The emitted electrons collected by the receiving tubes are utilized to determine an intensity of the incident flame in combustion systems. In such systems, however, high voltage potential is required to be maintained between the phototubes and the receiving tubes. In addition, with increase in temperature the performance and reliability of phototubes deteriorates thus making them unsuitable for many systems that are installed in environments with high temperature.

In flame detection, certain wavelengths of electromagnetic radiations are utilized more often to determine presence of flames. For better efficiency of flame detection systems, optical elements are utilized that are transparent to certain wavelengths. These optical systems allow certain wavelengths to pass and expose the photosensitive detectors in the detection systems. Moreover, optical elements are also utilized to avoid direct exposure of components of the detection system to high temperatures. However, such optical systems may also experience potential damage due to over exposure to high temperatures.

Modern electronics has made it convenient for detection systems to be built using semiconductor components. Semiconductor components also provide for a reduction in size of the detection systems. In addition, usage of semiconductor components also provides for greater stability at lower costs. To process signals received by the semiconductor components, signal processing electronics is employed in most flame detection systems. The signal processing electronics, which includes semiconductor components, is typically disposed proximate to the flame detection systems. Communication channels are employed to communicate the signal from flame detection systems to the signal processing units. In current systems, it has been observed that during such communication important information may be lost.

Signal processing units, to avoid communication losses, are disposed in a housing body that also hosts the flame detection system. However, since the housing body is placed close to the flame source, the temperature of the housing body may rise gradually. The increase in temperature of the housing may cause performance issues for the signal processing unit. To ensure that the temperature of the housing remains within the operating range of semiconductor components, additional cooling systems such as fans or liquid cooling need to be disposed near the housing. Inclusion of cooling system adds to the cost as well as weight of the flame detection systems, thus, rendering them unsuitable for usage in most applications.

Semiconductor components that include Silicon Carbide (SiC) or Silicon-on-Insulator (SOI), or Gallium Nitride (GaN) have been used in other electronic devices that are utilized in high temperature environments. SiC, or SOI components have also been used in signal processing units for flame detection systems. The SiC or SOI components provide consistent performance in combustion systems where the flame detection systems are placed. However, even with the usage of SiC or SOI components, currently available systems display current leakage during signal processing. Further, noise components are also added with an increased frequency of occurrence with increase in temperature.

Hence, there is a need for a method and system that provides for flame detection in harsh environment while displaying minimal loss and distortion due to noise signals.

### BRIEF DESCRIPTION

In one embodiment, a system for determination of presence of flames is provided. The system includes a photosensitive transducer that generates response signals based on electromagnetic radiation from a flame source. The photosensitive transducer is placed such that it is proximate to the flame source. Further, the system includes a signal processing unit. The signal processing unit includes a modulation unit that is configured to modulate the response signal with a modulation signal of frequency higher than that of an unwanted signal and generate a modulated response signal. Further, the signal processing unit includes a demodulation unit that is configured to determine an output signal from the modulated response signal. The demodulation unit is configured to eliminate unwanted signal from the modulated response signal to generate the output signal. The output signal is processed by a processing unit to determine the presence of a flame. The determination of presence of flames is based on an intensity of radiation from the flame.

In another embodiment, a method for determination of presence of flames is provided. The method includes acquiring response signal generated based on an incident radiation. Further, the method includes modulating the acquired response signal to generate a modulated response signal. The response signal is modulated using a modulation signal that has a frequency higher than that of an unwanted signal in the response signal. Furthermore, the method includes demodulating the modulated response signal to generate an output signal. Demodulation of the modulated response signal includes elimination of unwanted signal to determine the output signal. The method also includes the step of processing the output signal to determine the presence of a flame. The output signal is utilized to determine an intensity of the incident radiation, based on which presence of the flame is detected.

In yet another embodiment, a flame detection device is provided. The flame detection device includes a device housing. The flame detection device also includes a silicon carbide transducer that is configured to generate response signals that are a function of incident radiation from a flame originating from a flame source. Further, the device includes an optical device disposed at one end of the device housing. The optical device is configured to isolate the silicon carbide transducer from the flame source. Furthermore, the flame detection device includes a signal processing unit to process the response signals generated by the transducer. The signal processing unit includes at least one amplification unit configured to amplify the response signal. The signal processing unit also includes a modulation unit configured to generate modulated response signal by modulating the response signal with a modulation signal of frequency higher than that of an unwanted signal in the response signal. The signal processing unit further includes a demodulation unit configured to determine an output signal by demodulating the modulated response signal. The demodulation unit determines the output signal by eliminating unwanted signal from the modulated response signal.

### DRAWINGS

Other features and advantages of the present disclosure will be apparent from the following more detailed description of the preferred embodiment, taken in conjunction with the accompanying drawings which illustrate, by way of example, the principles of certain aspects of the disclosure.

FIG. 1 illustrates a schematic view of an environment in which the present invention can be practiced;

FIG. 2 illustrates a system for determination of flames disposed in the environment illustrated in FIG. 1;

FIG. 3 illustrates a schematic diagram of a signal processing unit, according to one embodiment of the present invention;

FIG. 4 illustrates a schematic diagram of a signal processing unit, according to another embodiment of the present invention; and

FIG. 5 is a flow chart illustrating a method for determination of presence of flames, according to one embodiment of the present invention.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

As will be discussed in greater detail below, embodiments of the present invention provide for a system and method for determining presence of flames in harsh environments. Detection of presence of flames is important in many systems such as fossil-fuel based combustion engines. Based on a nature of flames present in these systems, control activities are planned. Flame detection also plays an important part in determining a state of activity in a wide range of manufacturing processes. The system for flame detection is placed in systems such as combustion engines, such that the system is proximate to the flame source. In combustion engines, for example, flame sources can be a plurality of burners that consume fuel. The system for detection of flames is configured to detect presence of flames based on an intensity of radiation emitted by the flame source. The system, according to embodiments of the present invention, includes a photosensitive transducer. A photosensitive transducer, according to certain embodiments, can be a photodiode. The photosensitive transducer is configured to generate a response signal that is a function of the intensity of the radiation incident on it and originating from the flame source. The response signal is processed by a signal processing unit to determine the intensity of the flame. The signal processing unit comprises a modulation unit that is configured to modulate the response signal with a modulation signal. According to certain embodiments, the modulation signal is selected such that the frequency of the modulation signal is higher than that of the response signal. Further, the signal processing unit also includes a demodulation unit that is configured to eliminate unwanted signal from the modulated response signal and generate an output signal. The output signal is communicated to a processing unit to determine an intensity of the radiation responsible for the output signal. The processing unit, according to one embodiment, may determine the intensity of the radiation based on a relationship determined from historical data pertaining to amplitude of output signals and intensities of incident radiation.

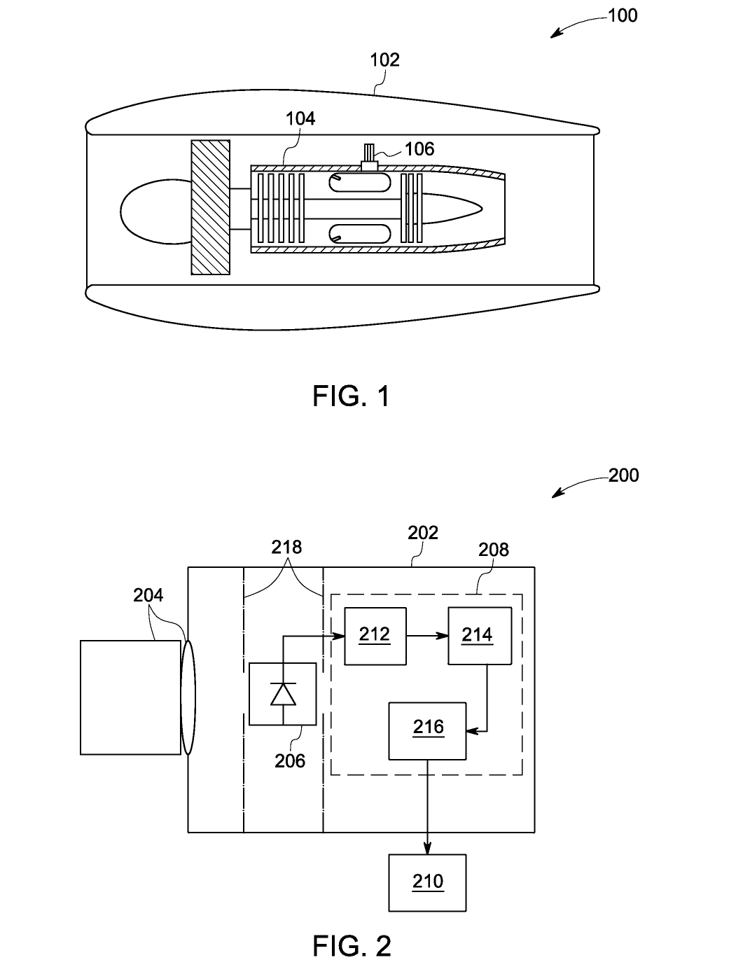

FIG. 1 illustrates a schematic view of a system 100 in which the present invention can be practiced. The system 100 includes, among other components, a gas turbine engine 102. The gas turbine engine 102 includes a combustion engine 104. The combustion engine 104 generates flames post consumption of fuel. The system for detection of presence of flames is placed proximate to the combustion engine 104 such that radiation from the flames is incident on the components of the system for determination of flames.

To avoid direct exposure to the flames in the combustion engine 104 by the system for determination of flames, optical elements may be placed between the system for determination of flames and the source of the flames i.e. the combustion engine 104. Optical elements include, but are not limited to lenses, optical fibers, windows, transparent glasses etc. The optical elements, in some embodiments, are placed in apertures made in walls of the system 100. For example, the optical elements can be placed in the aperture 106. The system for determination of flames is placed proximate to the optical elements. During operation when the combustion engine 104 produces flames, radiations from the flames are made to be incident on the system for determination of flames.

FIG. 2 illustrates a system 200 for determination of flames that may be disposed in the environment illustrated in FIG. 1. The system 200 includes a housing 202, optical element 204, a photosensitive transducer 206, a signal processing unit 208, and a processing unit 210. The system 200 is placed proximate to the source of flames, for example, the combustion engine 104 of the gas turbine engine 102. The housing 202 includes an opening on one end to place the optical element 204. The housing 202, according to certain embodiments, includes reflective material on an outside surface to reflect heat from the system 200. Further, inner layers of the housing 202 include thermally insulating material that protects the photosensitive transducer 206, and the components of the signal processing unit 208 from the heat generated at the flame source.

The optical element 204 of the system 200 that is placed at the opening of the housing 202 ensures that the photosensitive transducer 206 is not directly exposed to the heat generated at the flame source. The optical element 204, according to certain embodiments, may include at least one element that is transparent to particular wavelengths of electromagnetic radiation. The optical element 204 may include at least one of lenses, mirrors, reflective surfaces, transmissive surface and the like. In one embodiment, the optical element 204 includes lenses that are transparent to wavelength in the ultraviolet region of the electromagnetic spectrum. For example, the optical element 204 may include lens that is transparent to radiation in the 200 nm-400 nm wavelength range. In other embodiments, the optical element 204 includes mirrors that are configured to divert the electromagnetic radiation from the flame source to avoid direct exposure of the photosensitive transducer 206. Lenses that are transparent to ultraviolet radiation can be made from materials such as, but not limited to, quartz, germanium, and gallium arsenide.

The radiation that passes through the optical element 204 is incident on the photosensitive transducer 206. The photosensitive transducer 206 is a device that experiences a decrease in resistance upon exposure to light. The photosensitive transducer 206 generates current that is a function of the intensity of the incident radiation. Examples of photosensitive transducer 206 include photodiodes, phototransistors, and photoresistors. In certain embodiments, the photosensitive transducer 206 can be made from material such as Silicon Carbide (SiC), Silicon (Si), Silicon on Insulator (SOI), Aluminum Gallium Nitride (AlGaN), Zinc oxide (ZnO), diamond, Aluminum Nitride (AIN), and Boron Nitride (BN). The photosensitive transducer 206 is selected such that it can be used to operate in high temperatures. Operations in high temperatures are dependent on the material included in the photosensitive transducer 206. For example, when the photosensitive transducer 206 includes SiC, the operating temperature range may be greater than 300° C. Similarly, when the photosensitive transducer 206 includes SOI, the operating temperature range may be greater than 250° C. In other embodiments, the photosensitive transducer 206 may include other material suitable for usage in environments where temperatures are greater than temperature ranges in which SiC based or SOI based transducers can operate.

The photosensitive transducer 206 is configured to generate a response signal that is a function of electromagnetic radiation that is focused through the optical element 204. The response signal generated by the photosensitive transducer can be a current signal or a voltage signal. In one embodiment, the photosensitive transducer 206 generates a current signal that is communicated to the signal processing unit 208 for determination of intensity of the electromagnetic radiation.

The signal processing unit 208 and the photosensitive transducer 206 may be coupled by wired or wireless communication channels. In some embodiments, the signal processing unit 208 is disposed at a remote facility, where it is communicably coupled with the photosensitive transducer 206. In one embodiment, the signal from the photosensitive transducer 206 is amplified before being communicated to the signal processing unit 208 through wireless communication channels. As shown in FIG. 2, in some embodiments, the signal processing unit 208 may be disposed in the housing 202 such that the signal processing unit 208 is proximate to the photosensitive transducer 206. The signal processing unit 208 and the photosensitive transducer 206, when disposed in the housing 202, may be coupled through a wired communication channel. In one embodiment, the housing 202 includes at least one thermal break 218 such that a temperature gradient is created between the photosensitive transducer 206 and the signal processing unit 208. Further, in the housing 202, thermal break 218 may also be utilized to create a temperature gradient between the optical element 204 and the photosensitive transducer 206. The temperature gradients in the housing 202 may be created to maintain the photosensitive transducer 206 and the signal processing unit 208 in environments where the temperatures fall within their operating ranges.

The signal processing unit 208 includes an amplification unit 212, a modulation unit 214, and a demodulation unit 216. The amplification unit 212 is configured to amplify the response signal generated by the photosensitive transducer 206. When the photosensitive transducer 206 generates a current response signal in response to the incident electromagnetic radiation, the amplification unit 212 is configured to convert the current response signal to a voltage response signal. The voltage response signal generated by the amplification unit 212 is modulated by the modulation unit 214. The modulation unit 214 is configured to modulate the response signal with a modulation signal that has a frequency that is greater than the unwanted signal. The output of the amplification unit 212 that is received at the modulation unit 214 includes unwanted signals such as high temperature leakage signals, coupling based noise signals, offset signals added by the amplification unit 212, and high temperature drift signals as well as wanted signals. The modulation unit 214 is configured to modulate the response signal, including the unwanted signals, with the high frequency modulation signal to generate modulated response signal. Further, in the signal processing unit 208, the demodulation unit 216 receives the modulated response signal and determines an output signal. The demodulation unit 216 is configured to reject the modulation signal, and the low frequency unwanted signals that are present in the modulated response signal. The demodulation unit 216 thus retains only the response signal of the photosensitive transducer 204 that was shifted to a frequency range higher than the unwanted signals. The output signal determined at the demodulation unit 216 is communicated to the processing unit 210 that is configured to determine the intensity of the electromagnetic radiation. In some embodiments, the amplification unit 212 and the modulating unit 214 may be part of a single component.

The processing unit 210 determines the intensity of the electromagnetic radiation based on a relationship between at least one of amplitude and phase of the output signal and the intensity of radiation. The output signal determined by the signal processing unit 208 may be communicated to the processing unit 210 through wired or wireless communication channels.

The processing unit 210 may be configured to determine a relationship between the output signal and the intensity of the electromagnetic radiation based on historical information pertaining to output signals and intensities of the electromagnetic radiation.

The processing unit 210, in certain embodiments, may comprise a central processing unit (CPU) such as a microprocessor, or may comprise any suitable number of application specific integrated circuits working in cooperation to accomplish the functions of a CPU. The processing unit 210 may include a memory that can be an electronic, a magnetic, an optical, an electromagnetic, or an infrared system, apparatus, or device. Common forms of memory include hard disks, magnetic tape, Random Access Memory (RAM), a Programmable Read Only Memory (PROM), and EEPROM, or an optical storage device such as a re-writeable CDROM or DVD, for example. The processing unit 210 is capable of executing program instructions, related to the system for determination of presence of flames. Such program instructions will comprise a listing of executable instructions for implementing logical functions. The listing can be embodied in any computer-readable medium for use by or in connection with a computer-based system that can retrieve, process, and execute the instructions. Alternatively, some or all of the processing may be performed remotely by additional processing unit 210.

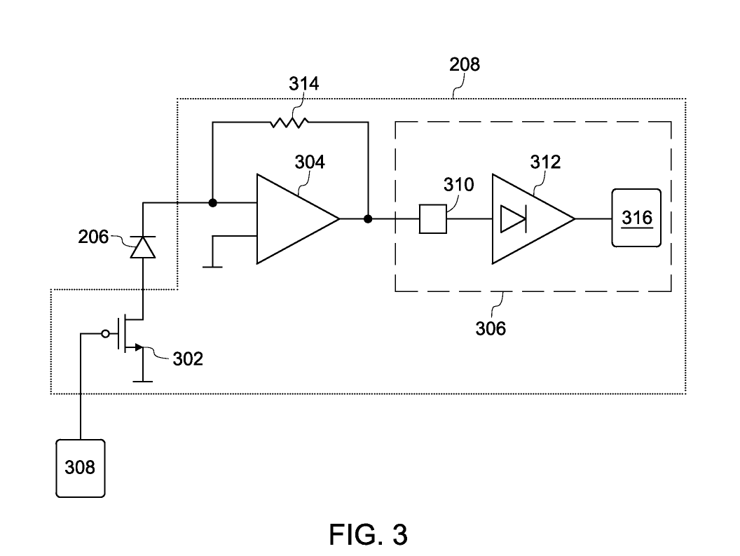

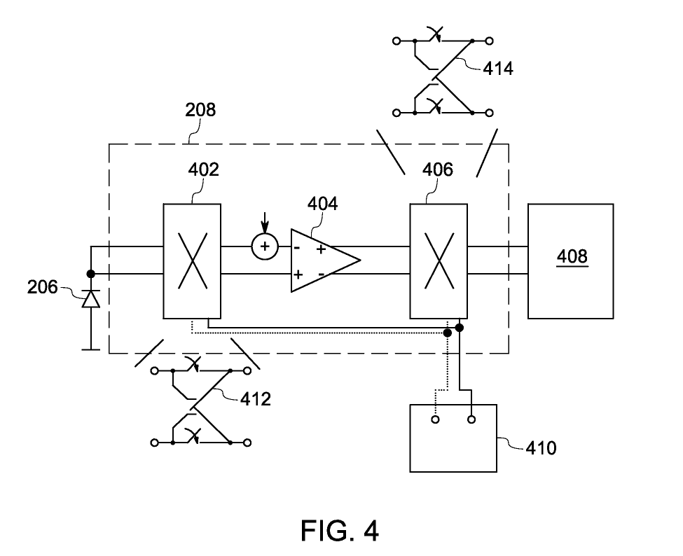

In various embodiments, the modulation unit 214 and the demodulation unit 216 include different components such as a wave rectifier, a capacitive element, a clock signal generator, and switches. Different architectures of these components can be utilized as modulation and demodulation unit 214 and 216. FIGS. 3 and 4 describe these architectures in greater detail.

FIG. 3 illustrates a schematic diagram of a signal processing unit 208, according to one embodiment of the present invention. The signal processing unit 208 as illustrated in FIG. 3 includes a modulation unit 302, a trans-impedance amplifier 304, and a demodulation unit 306. When the photosensitive transducer 206 is exposed to electromagnetic radiation generated at the flame source, the photosensitive transducer 206 generates a response signal that is a function of the incident electromagnetic radiation. The photosensitive transducer 206 illustrated in FIG. 3 is a photodiode. The photosensitive transducer 206, in other embodiments, may be a phototransistor, a photoresistor, or a phototube. The photodiode illustrated in FIG. 3 may be at least one of a SiC or SOI photodiode. Many commercially available photodiodes can be used as the photosensitive transducer 206.

The photosensitive transducer 206 and the signal processing unit 208 are disposed in the housing 202. The housing 202 includes thermal breaks at various points such that components of the signal processing unit 208, such as the modulation unit 302, the amplifier 304, and the demodulation unit 306 are placed in regions where the temperatures are within the operating range of these components.

The response signal from the photosensitive transducer 206 is communicated to the trans-impedance amplifier 304 of the signal processing unit 208. The trans-impedance amplifier 304 is configured to convert the current response signal of the photosensitive transducer 206 to a voltage response signal. The voltage response signal is measured across a resistive element 314 that is coupled with an input port and an output port of the amplifier 304.

The voltage response signal at the output port of the amplifier 304 is modulated with a modulation signal generated by the modulation unit 302. The modulation unit 302 may be at least one of a transistor, chopping circuit, micro-electro-mechanical system (MEMS) switch, or optical switch. In the embodiment illustrated in FIG. 3, the modulation unit 302 includes a metal-oxide-semiconductor field-effect transistor (MOSFET). The MOSFET acting as modulation unit 302, in one embodiment, includes SiC. In other embodiments, the MOSFET includes SOI. The modulation unit 302 is configured to generate a modulation signal that modulates the voltage response signal. The modulation signal generated by the modulation unit 302 is selected to have a frequency higher than that of unwanted signal from the response signal.

The modulation unit 302 is provided with a clock signal from a clock signal generator 308. The clock signal provided by the clock signal generator 308 drives the modulation unit 302 to generate the modulation signal. The clock signal frequency is selected based on the frequency required for the modulation signal. The modulation signal produced by the modulation unit 302 modulates the response signal to generate a modulated response signal. The modulated response signal includes a frequency-shifted original response signal obtained from the trans-impedance amplifier 304 and unwanted signals that get added to the response signal through the amplifier 304 and high temperature related offset and leakage signals. The unwanted signals are present at a lower frequency than that of the radiation generated components of the response signal. When the response signal gets modulated, the radiation generated components of the response signal are shifted to a frequency that is further higher than that of the unwanted signals. The demodulation unit 306 is configured to eliminate the lower frequency components of the modulated response signal and determine an output signal.

The demodulation unit 306 includes a high pass filter 310, a rectifier 312, and a filter 316. The high pass filter 310 is configured to eliminate unwanted low frequency components, such as DC components, present in the modulated response signal. In one embodiment, the high pass filter may be a capacitive element. Further, the rectifier 312 is configured to generate an output signal by eliminating the modulation signal, and low frequency unwanted signal components from the modulated response signal. The rectifier 312 is configured to convert positive and negative polarities of the modulated response signal into an output signal with a single polarity. In other words, the rectifier 312 is configured to determine a magnitude of the wanted components of the modulated response signal. In different embodiments, different architectures of rectifiers may be used as the rectifier 312. The rectifier 312, in one embodiment, may be a full wave rectifier. Examples of full wave rectifier architectures include, but are not limited to, center-tapped transformer based rectifiers, diode-bridge based rectifiers, and transistor-bridge based rectifiers. In another embodiment, the rectifier 312 may be a half wave rectifier. The rectifier 312 is configured to compute an absolute peak value of the AC components of the wanted signal. According to certain embodiments, the rectifier 312 may be configured to generate a root mean square (RMS) value of the AC components of the wanted signal. Electronic components in the rectifier 312 may comprise at least one of SiC, or SOI or GaN. The output signal is also further smoothened at peaks by the rectifier 312.

The low pass filter 316 is configured to smoothen the output signal at the rectifier 312 in such a way that high frequency unwanted components that may be present in the output signal are eliminated. Unwanted components that may be present in the output signal include, but are not limited to, clock noise from the clock signal generator 308, or noise signal from the rectifier 312, and the like. The low-pass filter 316 is coupled with the rectifier 312 to receive the output signal and is configured to filter the high frequency unwanted components that may be present in the output signal.

Furthermore, the signal processing unit 208 may include a current loop, for example a 4-20 mA current loop, configured to communicate the output signal to the processing unit 210. The processing unit 210 is configured to determine an intensity of the incident electromagnetic radiation based on the output signal.

FIG. 4 illustrates a schematic diagram of a signal processing unit 208, according to another embodiment of the present invention. The signal processing unit 208, as illustrated in FIG. 4, includes a modulation unit 402, an amplification unit 404, and a demodulation unit 406.

The response signal received from the photosensitive transducer 206 is communicated to the modulation unit 402. The modulation unit 402 is configured to modulate the response signal to generate a modulated response signal. The modulation unit 402, according to one embodiment, includes a switch configuration 412. The switch configuration 412 includes a plurality of switches (S1, S2, S3, and S4) that are configured to modulate the response signal to generate the modulated response signal. In one embodiment, each of the plurality of switches of the switch configuration 412 includes a SiC transistor. The switch configuration 412 is coupled with a clock signal generator 410. The clock signal generator 410 is configured to produce clock signals in such a fashion that S1 and S2 are switched on when the clock signal is in a positive state, and S3 and S4 are switched on when the clock signal is in a zero state. The modulation unit 402, due to the alternate operation of the switches in the switch configuration 412, produces a modulated response signal. The clock signal generated by the clock signal generator 410 has a frequency higher than that of unwanted signal present in the response signal received from the photosensitive transducer 206. The modulated response signal is amplified by the amplification unit 404. The amplification unit and the ambient temperature changes lead to an addition of unwanted signals in the modulated response signal.

The demodulation unit 406 is configured to determine the output signal from the modulated response signal by eliminating the unwanted signals and the modulation signal in the modulated response signal. The demodulation unit 406, in one embodiment, also includes a switch configuration 414 that is coupled with the clock signal generator 410.

During operation of the signal processing unit 208, switches of the switch configuration 412 and 414 are operated such that the modulation signal added at the modulation unit 402 is eliminated at the demodulation unit 406 and the unwanted signal is further modulated away from the wanted signal.

In one embodiment, the switch configurations 412 and 414 include transistors as switches S1, S2, S3, and S4. Transistors, according to one embodiment may include Silicon Carbide (SiC). The presence of SiC in the switches S1, S2, S3, and S4 allows for operations at greater temperatures without leading to an increase in the unwanted signals. According to other embodiments, the switches in the switch configurations 412 and 414 include, but are not limited to, optical switches, MEMS, and the like. The output signal obtained at the demodulation unit 406 may then be amplified by a second amplifier 408 that is coupled with the output of the demodulation unit 406.

In certain embodiments, the demodulation unit 406 may include a high pass filter, and a low-pass filter. The high pass filter is configured to eliminate unwanted low frequency components, such as DC components, present in the modulated response signal. In one embodiment, the high pass filter may be a capacitive element. Electronic components in the filters may comprise at least one of SiC, or SOI or GaN. The output signal at the demodulation unit 406 may also be further smoothened at peaks by the low-pass filter.

The low pass filter is configured to smoothen the output signal in such a way that high frequency unwanted components that may be present in the output signal are eliminated. Unwanted components that may be present in the output signal include, but are not limited to, clock noise from the clock signal generator 410, or noise signal from the switches in the switch configurations 412 and 414, or unwanted modulation signal, and the like.

Furthermore, the signal processing unit 208 may include a current loop, for example a 4-20 mA current loop, configured to communicate the output signal to the processing unit 210. The processing unit 210 is configured to determine an intensity of the incident electromagnetic radiation based on the output signal.

The photosensitive transducer 206, and the signal processing unit 208 are disposed in the housing 202. The housing 202 includes thermal breaks at various points such that components of the signal processing unit 208, such as amplification unit 404, modulation unit 402, and the demodulation unit 406 are placed in regions where the temperatures are within the operating range of these components.

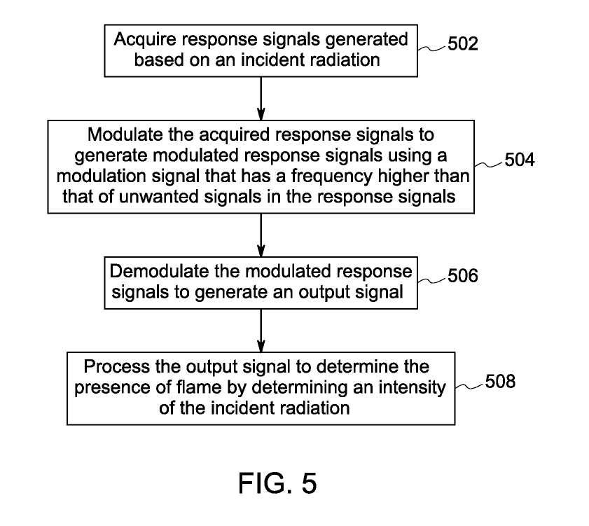

FIG. 5 is a flow chart illustrating a method for determination of presence of flames, according to one embodiment of the present invention. At 502, response signals generated by the photosensitive transducer 206 are acquired. The photosensitive transducer 206 produces the response signals based on the incident electromagnetic radiation. Electromagnetic radiation from a flame source may be focused on the photosensitive transducer 206 with the help of optical elements 204 that are disposed to filter certain wavelengths from the generated electromagnetic radiation. The photosensitive transducer 206 generates response signals that are a function of the incident electromagnetic radiation. The response signals from the photosensitive transducer 206 are communicated to the signal processing unit 208.

At step 504, the signal processing unit 208 is configured to modulate the acquired response signals to generate modulated response signals. The signal processing unit 208 includes a modulation unit that is configured to modulate the response signals. The modulation unit, such as the modulation unit 302 or 402, modulates the response signals with a modulation signal that has a frequency greater than that of the response signals. The modulation unit is coupled with a clock signal generator, for example clock signal generator 410, that generates clock signals that operate the modulation unit and help in modulating the response signals.

At 506, the modulated response signal is demodulated by a demodulation unit. The demodulation unit, for example demodulation unit 306, and 406, is configured to demodulate the modulated response signal such that unwanted signals from the modulated response signal, which get added during modulation and due to drift in signals caused by high temperatures, are eliminated. The demodulation unit, in certain embodiments, includes a plurality of switches that are coupled with the clock signal generator. The clock signal generator produces clock signals thereby alternating the state of switches in the demodulation unit. The change in state of switches of the demodulation unit leads to removal of the unwanted signals while determining the output signal.

At 508, the output signal is communicated to a processing unit, for example the processing unit 210, for determination of the intensity of the incident electromagnetic radiation. The processing unit is configured to determine the intensity of the incident electromagnetic radiation based on a relationship between parameters pertaining to the response signal, for example amplitude or phase of the response signal, and intensity of the incident electromagnetic radiation.

In certain embodiments, a high pass filter is employed to eliminate unwanted low frequency components, such as DC components, present in the modulated response signal. In one embodiment, the high pass filter may be a capacitive element. The output signal at the demodulation unit 406 may also be further smoothened at peaks by a low-pass filter.

The method and system for determination of presence of flames, as described in the preceding paragraphs, operates in harsh environments where temperatures are expected to rise above 200° C. The SiC and SOI based components such as amplifiers, switches, modulation and demodulation units enable the system to be utilized in environments such as gas turbine engines. The need for cooling systems to be installed along with the system for determination is eliminated as the system can be used at higher temperatures without loss of efficiency. Further, the temperature gradient provided by the housing enables disposing the signal processing unit in close proximity with the photosensitive transducer. The close proximity between the signal processing unit and the photosensitive transducer allows for usage of wireless communication channels, as well as, simple wired communication channels between the signal processing unit and the transducer. The costs of establishing communication between the transducer and the processing unit are thus reduced. In addition, data losses caused by other long distance communication channels are also reduced. Further, little to no processing is required on the output signal determined by the signal processing unit, thereby reducing the time taken and the processing requirement for determination of flames.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example. Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that is presented here by way of example and not limitation. Such networking environments are commonplace in office-wide or enterprise-wide computer networks, intranets and the Internet, and may use a wide variety of different communication protocols. Those skilled in the art will appreciate that such network-computing environments will typically encompass many types of computer system configurations, including personal computers, handheld devices, multi-processor systems, microprocessor-based or programmable consumer electronics, network PCs, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described system and method for determination of flames in harsh environments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A system comprising:
a photosensitive transducer configured to generate a response signal that is a function of electromagnetic radiation from a flame source that is proximate to the photosensitive transducer; and
a signal processing unit, comprising:
a modulation unit configured to generate a modulated response signal by modulating the response signal with a modulation signal having a frequency higher than that of an unwanted signal present in the response signal; and
a demodulation unit configured to determine an output signal by demodulating the modulated response signal, wherein the demodulation unit is configured to eliminate the unwanted signal from the modulated response signal; and
a processing unit configured to process the output signal to determine flame presence based on the intensity of the incident radiation from the flame.

2. The system as recited in claim 1 further comprising a housing configured to hold one or both of the photosensitive transducer and the signal processing unit, wherein the housing comprises a plurality of thermal breaks to create at least one temperature gradient.

3. The system as recited in claim 1, wherein the modulation unit comprises at least one of a mechanical chopper, a micro-electro-mechanical system (MEMS) switch, an optical switch, and a transistor.

4. The system as recited in claim 1, wherein the demodulation unit further comprises a rectifier configured to convert the modulated response signal into the output signal by eliminating the modulation signal and the unwanted signal from the modulated response signal.

5. The system as recited in claim 1, further comprising a high-pass filter operatively coupled to the modulation unit and configured to eliminate low frequency unwanted signal from the modulated response signal.

6. The system as recited in claim 1, further comprising a low-pass filter coupled with the demodulation unit to smoothen the output signal.

7. The system as recited in claim 1, wherein the demodulation unit comprises a switching device configured to demodulate the modulated response signal and further modulate the unwanted signal present in the modulated response signal.

8. The system as recited in claim 1, wherein the demodulation unit comprises:
a switching device configured to demodulate the modulated response signal; and
a high-pass filter configured to eliminate low-frequency unwanted signal from the modulated response signal.

9. The system as recited in claim 7, wherein the switching device comprises at least one transistor.

10. The system as recited in claim 1, further comprising at least one clock signal generator.

11. The system recited in claim 1 wherein the signal processing unit comprises high temperature capable electronic components.

12. The system recited in claim 11 wherein the signal processing unit comprises wide band-gap transistors.

13. A method for determination of presence of flames, comprising:
acquiring a response signal generated based on an incident radiation;
modulating the acquired response signal to generate a modulated response signal, wherein the response signal is modulated using a modulation signal that has a frequency higher than that of an unwanted signal present in the response signal;
demodulating the modulated response signal to generate an output signal, wherein demodulating comprising elimination of the unwanted signal from the modulated response signal; and
processing the output signal to determine the presence of flame, wherein the output signal is utilized to determine an intensity of the incident radiation.

14. The method as recited in claim 13, wherein the response signal comprise current signal generated by a transducer.

15. The method as recited in claim 14, further comprising amplifying the response signal, wherein amplifying the response signal comprises converting the current signal to an equivalent voltage signal.

16. The method as recited in claim 13 further comprising converting an AC component of the modulated response signal to an absolute peak value or a root mean square (RMS) value.

17. The method as recited in claim 13, wherein demodulating the modulated response signal further comprising modulating the unwanted signal.

18. A flame detection device, comprising:
a device housing;
a silicon carbide transducer configured to generate response signals that are a function of incident radiation from a flame originating from a flame source;
an optical device disposed at one end of the device housing, wherein the optical device is configured to isolate the silicon carbide transducer from the flame source; and
a signal processing unit, comprising:
at least one amplification unit configured to amplify the response signal;
a modulation unit configured to generate a modulated response signal by modulating the response signal with a modulation signal having a frequency higher than that of an unwanted signal present in the response signal; and
a demodulation unit configured to determine an output signal by demodulating the modulated response signal, wherein the demodulation unit is configured to eliminate the unwanted signal from the modulated response signal.

19. The device recited in claim 18, wherein the demodulation unit comprises a rectifier configured to determine at least one of an absolute peak value of AC components or a root mean square (RMS) value of AC components from the modulated response signal.

20. The device as recited in claim 18, wherein the demodulation unit comprises a switching device configured to demodulate the modulated response signal and further modulate the unwanted signal.
